(19) United States
(12) Patent Application Publication
(10) Pub. No.: US 2026/0105870 A1
(43) Pub. Date: Apr. 16, 2026

(54) SYSTEMS, DEVICES, ARTICLES AND METHODS FOR SLIDABLE VEHICLE DISPLAY SIGN HOLDER

(71) Applicant: 1313 Electric, Surrey (CA)

(72) Inventor: Yohan Okyere, Surrey (CA)

(73) Assignee: 1313 Electric, Surrey (CA)

(21) Appl. No.: 19/351,059

(22) Filed: Oct. 6, 2025

Related U.S. Application Data
(60) Provisional application No. 63/706,285, filed on Oct. 11, 2024.

(51) Int. Cl. G09F 7/20; B60R 13/10; G09F 7/18

(52) U.S. Cl. CPC G09F 7/20; B60R 13/105; G09F 2007/1865; G09F 2007/1895

(57) ABSTRACT

Embodiments of the present disclosure relate to systems, devices, and methods for a slidable vehicle display sign holder. The sign holder is an automated device which can display or hide signs based on user input. The sign holder includes a housing that includes a sign affixed to a sign carrier, an actuator to extend or retract the sign carrier, a controller including circuitry (e.g., microprocessor) to control the movement of the sign carrier and a power source to supply power to the controller and the circuitry. The sign holder is communicatively coupled to a processor-based user device which can be used to provide instructions to the sign carrier. In some examples, the sign holder includes sensors (e.g., accelerometers, Hall effect sensors, inertial measurement units, or limit switches) and uses input from the sensors to update the position of the sign carrier based on data received from the sensors (e.g., using a finite state machine).

### TECHNICAL FIELD

The disclosure generally relates to displaying information in proximity to the license plate of a vehicle on an as-needed basis. More particularly, the disclosure relates to systems, devices, articles, and methods for allowing vehicle users to display or hide signs (e.g., badges, cards, decals, or stickers) near (e.g., beside, beneath, or behind) a vehicle license plate.

### BACKGROUND

The purpose of the following description of related art is solely to provide background information pertaining to the relevant field of the disclosure. Note that this section is only to enhance the understanding of the reader with respect to the present disclosure. Therefore, unless otherwise indicated, it should not be assumed that any of the information described in this section qualifies as prior art merely by inclusion in this section.

Currently, vehicle information displays come in many forms such as magnetic displays, stickers, decals, and electronic displays. The information can be a simple sticker or a service indicator such as ridesharing or ride hailing, courier, first responder, food delivery, and freight transport, as well as information about the vehicle (for example, electric/hybrid) and the driver (new driver, learner, etc.) and passengers, such as “baby on board” and handicapped signs. These signs can be affixed by adhesives, magnets, and suction cups.

### SUMMARY

This section is intended to introduce certain objectives and aspects of the present disclosure in a simplified manner.

The disclosure relates to a device for the selective display of a sign on a vehicle. In some embodiments, the device includes a frame including a first side and a second side, which in operation is coupled to the vehicle on the first side of the frame and receives a license plate on the second side of the frame, a sign carrier to receive the sign, and an actuator coupled to the frame and the sign carrier, which in operation moves the sign carrier from a first position to a second position. In some embodiments, the device includes a power supply coupled to the frame and electrically coupled to the actuator, and a controller communicatively coupled to the actuator.

In some embodiments, first position of the device hides a first part of the sign behind the license plate or the frame and the second position displays the sign clear of the frame and the license plate. In another embodiment, the sign carrier is in a sliding engagement with the frame. The device also includes a plurality of bearings separating the frame from the sign carrier. In yet another embodiment, the actuator is a linear actuator including a motor, a lead screw coupled to the motor, a threaded body coupled to the sign carrier and threaded on the leadscrew and is selected from the group consisting of a rack and pinion and a linear actuator.

Further, the embodiments of the present disclosure encompass a system including a user device which is processor-based; at least one processor communicatively coupled to the user device; and at least one non-transitory processor-readable storage device communicatively coupled to the at least one processor and which stores processor-executable instructions which, when executed by the at least one processor, cause the at least one processor to: receive a user input through a GUI on the processor-based user device which specifies a behavior for a slider communicatively coupled to the user device; detect pose or movement of a vehicle coupled to a sign carrier and adjust the position of the sign carrier based on the user input, pose of the sign carrier, or movement of the sign carrier.

In some embodiments, the system includes a slider communicatively coupled to the at least one processor and the slider includes an actuator coupled to the sign carrier, which when executed, the processor-executable instructions further cause the at least one processor to pair the user device with the slider including the sign carrier. In another embodiment, the processor-executable instructions further cause the at least one processor to receive a preset input, a speed threshold, a movement threshold and an action to be done upon reaching the movement threshold for the slider through the GUI on the processor-based user device.

In yet other embodiments, the sign carrier is coupled to a vehicle; the sign carrier may receive a sign; the movement of the sign carrier includes movement of the sign carrier by way of movement of the vehicle; the position of the sign carrier is relative to the vehicle; a first position hides the sign and a second position displays the sign; and when executed, the processor-executable instructions further cause the at least one processor to adjust the position of the sign carrier from the first position to the second position, or from the second position to the first position.

The disclosure relates to a system including a user device, at least one processor communicatively coupled to the user device, and at least one non-transitory processor-readable storage device communicatively coupled to the at least one processor. The user device is processor-based. The at least one non-transitory processor-readable storage device stores processor-executable instructions which, when executed by the at least one processor, cause the at least one processor to: receive a user input through a GUI on the processor-based user device, detect pose or movement of a vehicle coupled to a sign carrier, and adjust the position of the sign carrier based on the user input, pose of the sign carrier, or movement of the sign carrier. The user input specifies a behaviour for a slider communicatively coupled to the user device.

This summary does not necessarily describe the entire scope of all aspects of the disclosure. Other aspects, features, and advantages will be apparent to those of ordinary skill in the art upon review of the following description of specific embodiments.

### BRIEF DESCRIPTION OF THE DRAWINGS

Systems, devices, and methods are described in greater detail herein with reference to the following figures in which:

FIG. 1 illustrates a block diagram of a license plate and a vehicle display sign holder in accordance with some embodiments of the invention.

FIG. 2 illustrates a perspective view of an embodiment of the vehicle display sign holder of FIG. 1 in a slide closed configuration.

FIG. 3 illustrates a perspective view of the vehicle display sign holder of FIG. 2 in a slide-open configuration.

FIG. 4 illustrates a perspective view of an embodiment of a frame included in a vehicle display sign holder.

FIG. 5 illustrates a perspective view of an embodiment of a sign carrier.

FIG. 6 illustrates a perspective view of the frame shown in FIG. 4 and the sign carrier shown in FIG. 5.

FIG. 7 illustrates a perspective view of an embodiment of a cover included in a vehicle display sign holder.

FIG. 8 illustrates a schematic view or block diagram of a plurality of circuits in accordance with some embodiments of the invention.

FIG. 9 illustrates an exemplary method for use with the plurality of circuits of FIG. 8.

FIG. 10 is a further illustration of an exemplary method for use with the plurality of circuits of FIG. 8.

FIG. 11 illustrates a state diagram in accordance with some embodiments of the invention.

FIG. 12 and FIG. 13 illustrate a user device interface (GUI) in accordance with some embodiments of the invention.

The above-mentioned drawings illustrate exemplary embodiments of the disclosed methods and systems in which like reference numerals refer to the same parts throughout the different drawings. Components in the drawings are not necessarily to scale, as emphasis is placed on clearly illustrating the principles of the inventions. Some drawings may use block or schematic diagrams and thus represent without showing details such as internal circuitry of components. Also, the embodiments shown in the figures are not to be construed as limiting the inventions but only as illustrative examples of an automated method and system according to the inventions that are illustrated herein to highlight the advantages of the inventions.

### DETAILED DESCRIPTION

In the following description, associated drawings, included claims, and other parts of the document, various details are set forth to provide a detailed understanding of the disclosure and embodiments thereof. It will be apparent, however, that the disclosed embodiments may be practiced without some of these details. Several features described hereafter can each be used independently of one another or in combination of other features.

Currently, vehicle display signs come in many forms. For example, the High Occupancy Vehicle (HOV) lane stickers, such as “EV-OK” stickers that allow qualifying low-emission vehicles such as Battery electric vehicles, Hydrogen fuel cell vehicles, Plug-in hybrid electric vehicles and Extended-range electric vehicles to use the HOV lane on highways regardless of the number of passengers. This type of sticker needs to be displayed at the rear of the vehicle and is only needed to be displayed when the vehicle is on an allowed highway.

The Applicant appreciates that vehicle users may leave such displays visible to the public at all times, although it is not always necessary and may lead to confusion and interference as well as be aesthetically unappealing. For example, a vehicle driver that is providing ride-hailing services such as UBER® and LYFT® during the week may not need to display the service provider logos when they are off duty. Similarly, a driver may choose to display a “baby-on-board” sign only when a child passenger is on board and a handicapped placard only when a qualified individual is using the vehicle. Moreover, if the vehicle is a rental any such displays need to be safely removed before returning the vehicle.

This increasing number of signs, decals and displays could make vehicle less appealing in appearance, and removing and attaching stickers and magnetic signs could scratch and damage the exterior of the vehicle. Therefore, there is a need for a single integrated platform to display whichever card, sign, sticker, badge or decal whenever the user wishes without leaving any scratches or marks on the interior/exterior of the vehicle while maintaining the aesthetic appeal.

Hence, in view of the above-mentioned problems and challenges, the Applicant appreciates there is a need for an efficient and minimally-invasive system and method for storing and displaying vehicle display signs (for example, badges, cards, decals, placards, and stickers) without permanent affixation.

Embodiments shared in the present disclosure relate to a system, device, article and method for a slidable vehicle display sign holder (a.k.a., “electric slider”). A user who wishes to display a certain sign may purchase an electric slider and install it on the exterior of a vehicle, such as behind the rear registration plate or license plate. The user may then download the relevant software application on their preferred device (for example, a smartphone) and wirelessly connect the device to the electric slider. Once connected, the user may use the commands available on the software application to slide out (open) the electric slider, attach the preferred sign and retract the electric slider. The electric slider stays put behind the rear license plate until the vehicle reaches a speed of 20 km/hr and automatically slides open to display the preferred sign. This provides the user the option to display information about the vehicle, its driver and passengers in a non-invasive manner while maintaining aesthetic appeal.

As used herein, the term “electric slider” or “slider” refers to a vehicle display sign holder that is able to automatically slide out and slide in, extend to display or retract to hide signs.

As used herein, the terms “sign carrier”, “carrier”, “slide”, “stage” and like refer to the same interpretation and may be interchangeably used throughout the specification. The vehicle may include a passenger vehicle, such as a car, van, bus or a cargo vehicle such as a truck. Similarly, “vehicle”, “car”, “rental”, and like refer to the same interpretation and may be used interchangeably.

As used herein, the terms “passenger”, “traveller” and “driver” may refer to the same person and the terms may be interchangeably used throughout the specification. In particular, “driver”, and “user” may refer to the same person.

The term “a” or “an” when used in conjunction with the terms “comprise”, “include”, “comprising”, or “including” in the claims or the specification may mean “one”, “one or more”, “at least one”, and “a plurality” unless the content dictates otherwise. Similarly, the word “another” means “additional” or “at least a second” unless the content clearly dictates otherwise. The terms “or” and “and/or” herein when used in association with a list of items, means any one or more of the items may be selected from that list.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled or coupling can indicate that two units or devices are directly connected to one another or indirectly coupled to one another through one or more intermediate elements or devices by an electrical element, electrical signal or a mechanical element, depending on the particular context. For example, as used herein, the term connected can indicate that two components are directly connected to one another.

As used herein, “input”, “send”, “transfer”, “transmit”, “receive”, “output” and their cognate terms refer to sending and/or receiving information from one unit to another unit of the system, wherein said information refer to all the data mentioned in the disclosure and may or may not be modified before or after sending and receiving the information according to the desired requirements.

The I/O device(s) as used herein includes one or more user interface input devices, such as a display, a keyboard, a mouse, a microphone, and a camera. The one or more user interface input devices may be detachable. In some embodiments, the I/O device(s) includes one or more output devices, such as displays, speakers, and lights. In some embodiments, the I/O device(s) is a single light. The one or more I/O devices may be detachable. The I/O device(s) may include one or more sensors (such as speedometers, transducers, magnetic limit switches, clocks) and output devices (such as actuators, displays, lights).

The processor may be any logic processing unit such as one or more microprocessors, central processing units (CPUs), digital signal processors (DSPs), graphics processing units (GPUs), application-specific integrated circuits (ASICs), programmable gate arrays (PGAs), programmed logic units (PLUs) or any such device as may be obvious to a person skilled in the art. The processor may include, but is not limited to, a processor or set of processors or any such processing unit as may be obvious to a person skilled in the art, which are configured to function in accordance with the one or more inventions described herein. The terms ‘processor’ and ‘processing unit’ may be interchangeably used throughout the specification.

The circuits as used herein refer to any components, units, hardware elements, or any such unit as may be obvious to a person skilled in the art.

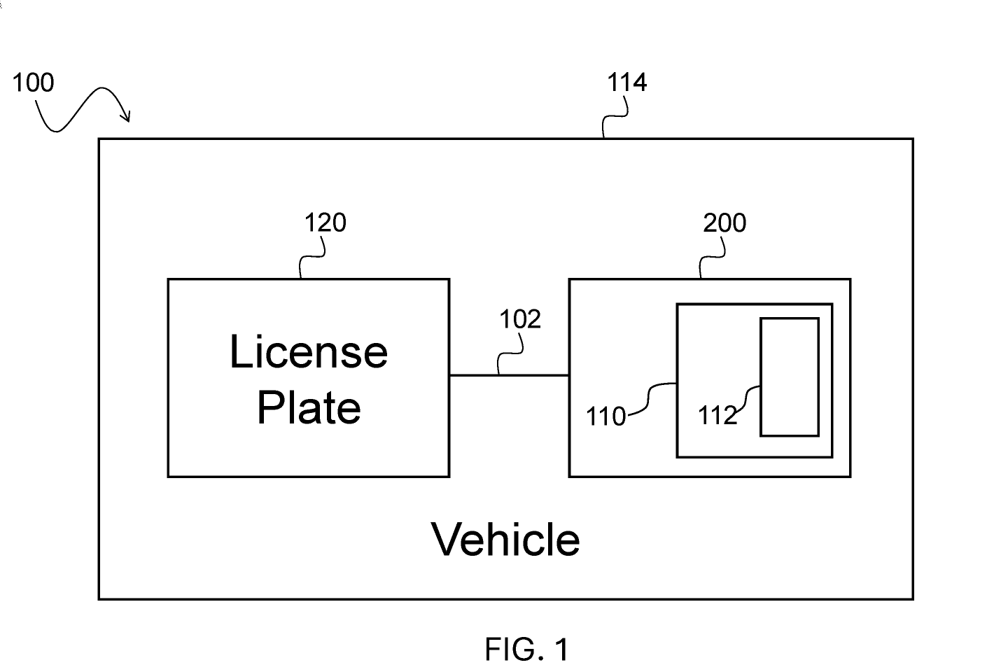

FIG. 1 illustrates a block diagram of vehicle plate system 100 in accordance with some embodiments of the invention. The plurality of vehicle plate system 100 includes slider 200, sign carrier 110, sign 112 and license plate 120. Slider 200 and license plate 120 are mounted to the rear exterior of a vehicle 114. Coupler 102 shows that in some embodiments, license plate 120 and slider 200 can be mounted together such that slider 200 is disposed in between the rear exterior of vehicle 114 and license plate 120.

Slider 200 can be mounted to the exterior of a vehicle via any attachment means, such as, adhesives, fasteners, magnets, screws, Velcro, etc. Similarly, license plate 120 can be attached to slider 200 by any suitable attachment means. License plate 120 and slider 200 therefore, include apertures or common mounting holes to receive fasteners such as screws. In some embodiments, slider 200 and license plate 120 can be attached to the exterior of a vehicle independently of each other.

In some embodiments, slider 200 has similar dimensions as license plate 120 or slightly smaller dimensions than license plate 120 such that slider 200 is hidden behind license plate 120. For example, slider 200 is approximately 305 mm (12 inches) long and 152 mm (6 inches) wide. In some embodiments slider 200 has dimensions selected from the group consisting of: 520 mm by 110 mm (20.5 by 4.3 inches), 520 mm by 120 mm (20.5 by 4.7 inches), 400 mm by 130 mm (15.7 by 5.1 inches), 300 mm by 150 mm (11.8 by 5.9 inches), 372 mm by 135 mm (14.6 by 5.3 inches), or 200 mm by 130 mm (8 by 5 inches). In some embodiments, the dimensions of slider 200 has a 1% tolerance. In some other embodiments, the tolerance is 2% and in yet another embodiment, the tolerance is 5%.

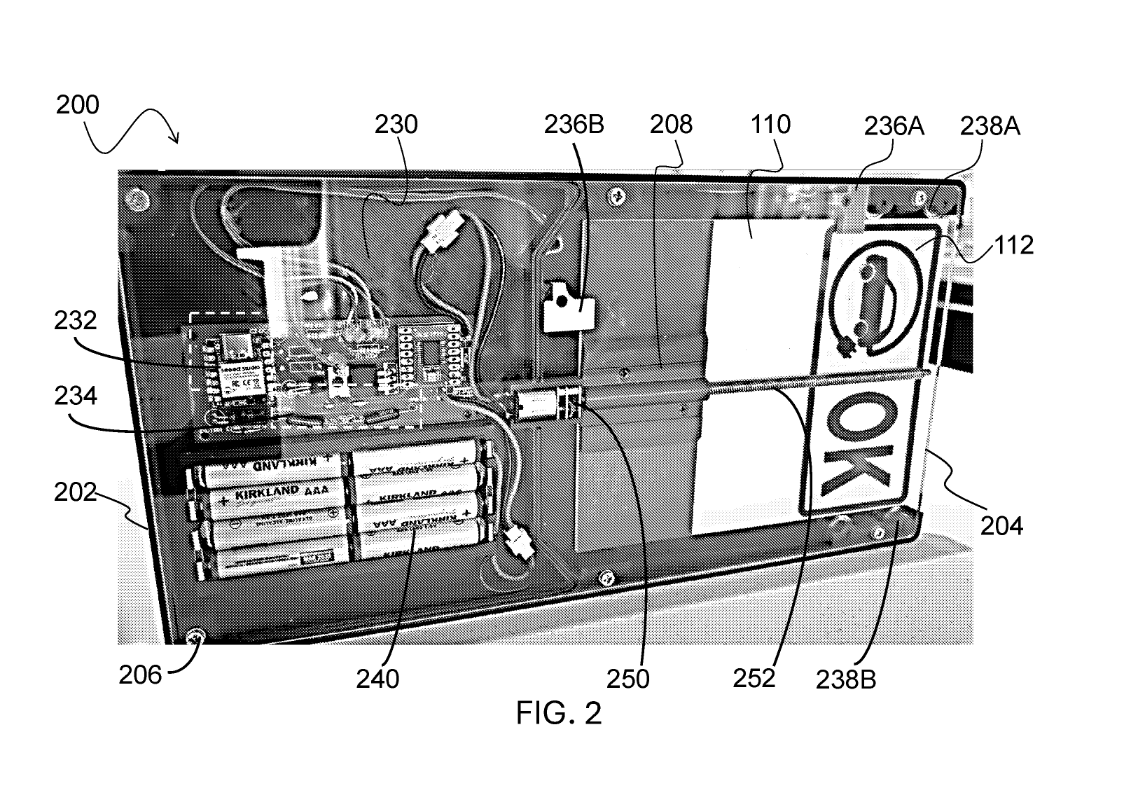

FIG. 2 illustrates a perspective view of slider 200 in accordance with some embodiments of the invention. Slider 200 is securely housed in an enclosure comprising frame 202 and cover 204, to weatherproof or protect slider 200 from the elements and tampering. Cover 204 is illustrated as clear to help show further aspects of slider 200. In some embodiments, slider 200 includes circuitry 230, a power source such as battery 240, motor 250, and sign carrier 110. As shown, sign carrier 110 is coupled to sign 112. Circuitry 230 is a conglomeration of electronic components such as microcontroller unit (MCU) 232, centrifugal switch 234, limit switch 236A and limit switch 236B, bearing 238A and bearing 238B , and other electrical and mechanical components such as magnets, motor shield, and motor driver (not shown). Motor 250 is coupled to lead screw 252 which, together act as a linear actuator allowing for movement (e.g., slide)of sign carrier 110 containing sign 112.

MCU 232 includes or is coupled to an antenna communicatively coupled to a receiver (e.g., a transceiver) (not shown) housed in circuitry 230, which, in operation, communicatively couples slider 200 and a processor-based user device such as a smartphone (not shown and described herein). The antenna can be a Radio Frequency (RF) antenna which is capable of operating Bluetooth, cellular and other types of low-power wireless communication networks.

Motor 250 is a standard DC motor operatively coupled to lead screw 252. In some embodiments, lead screw 252 is a wide tooth, long shaft (for example, 150 mm lead or worm gear shaft) which rotates clockwise/counter clockwise according to the rotation of motor 250. Motor 250 is controlled by MCU 232, which directs power to motor 250 from battery 240.

In some embodiments, as an added benefit, slider 200 comes as a standalone system powered by battery 240 and therefore, does not draw any power from the vehicle. Further, there is no need to splice into any circuit in the vehicle or compromise the envelope of the vehicle. This allows for easy installation of slider 200 while ensuring that it stays on/off regardless of the state of the vehicle. In some embodiments, battery 240 includes eight standard AAA batteries capable of delivering 8 – 12 Ah or any other power source of suitable capacity. For example, in some embodiments, battery 240 has a capacity of 1 to 100 Ah.

In some embodiments, frame 202 and cover 204 are held together by fasteners. For example, a plurality of screws 206. In some embodiments, plurality of screws includes at least six screws. Frame 202 and cover 204 can have aligned screw holes to receive screws 206. However, in some embodiments, frame 202 includes top and bottom railings to allow cover 204 to slide out (open) and in (close) without the use of screws 206. It is important to note that the aligned screw holes of frame 202 and cover 204 can also align with the mounting holes of license plate 120 to allow for easy and secure mounting of license plate 120 to slider 200 using screws 206. Furthermore, by aligning the screw holes of slider 200 with the mounting holes of license plate 120 allows for both slider 200 and license plate 120 to be easily attached to the rear exterior of a vehicle using the same or slightly longer screws as one would do when mounting a license plate to a vehicle.

In some embodiments, lead screw 252 is coupled with sign carrier 110 by attaching sign carrier 110 to nut 208. For example, using at least two screws (not shown) or both a unitary piece. Lead screw 252 threads into nut 208, and as motor 250 drives lead screw 252 with the constraint provided by frame 202, sign carrier 110 is forced in a linear direction. As shown, clockwise rotation of lead screw 252 causes sign carrier 110 (and nut 208) to slide out/extend at least partially beyond the dimensions of license plate 120, which allows for display of sign 112. Similarly, counter-clockwise rotation of lead screw 252 causes sign carrier 110 to slide back in/retract when the user chooses not to display sign 112. Sign carrier 110 is further secured on bearing 238A and bearing 238B, which allow for sign carrier 110 to slide. Bearings 238 are standard stainless steel groove bearings or any other type of bearing that are able to support and allow for the movement of sign carrier 110.

Any type of sign 112 can be affixed to sign carrier 110. Sign 112 can be affixed to sign carrier 110 by adhesives or an adhesive backing or any other type of attachment means, such as magnets, clips, fasteners, etc., given that sign 112 is able to freely move in and out of slider 200. Sign 112 may thus be an EV-OK sign, a new driver sign, a baby-on-board sign, a handicapped sign, a parking pass, a hotel guest sign or any other type of sign, sticker, badge or decal. In some embodiments, the user is able to display multiple signs at once (for example, the signs being adjacent to each other) as long as the signs fit securely within the dimensions of sign carrier 110. For example, in some embodiments, sign carrier 110 has a maximum display length of 12 cm and a maximum display width of 11 cm on which any sign(s) less than a total surface area of 132 cm2 can be attached. A person skilled in the art will appreciate that sign carrier 110 can have other suitable display dimensions not described in the example above.

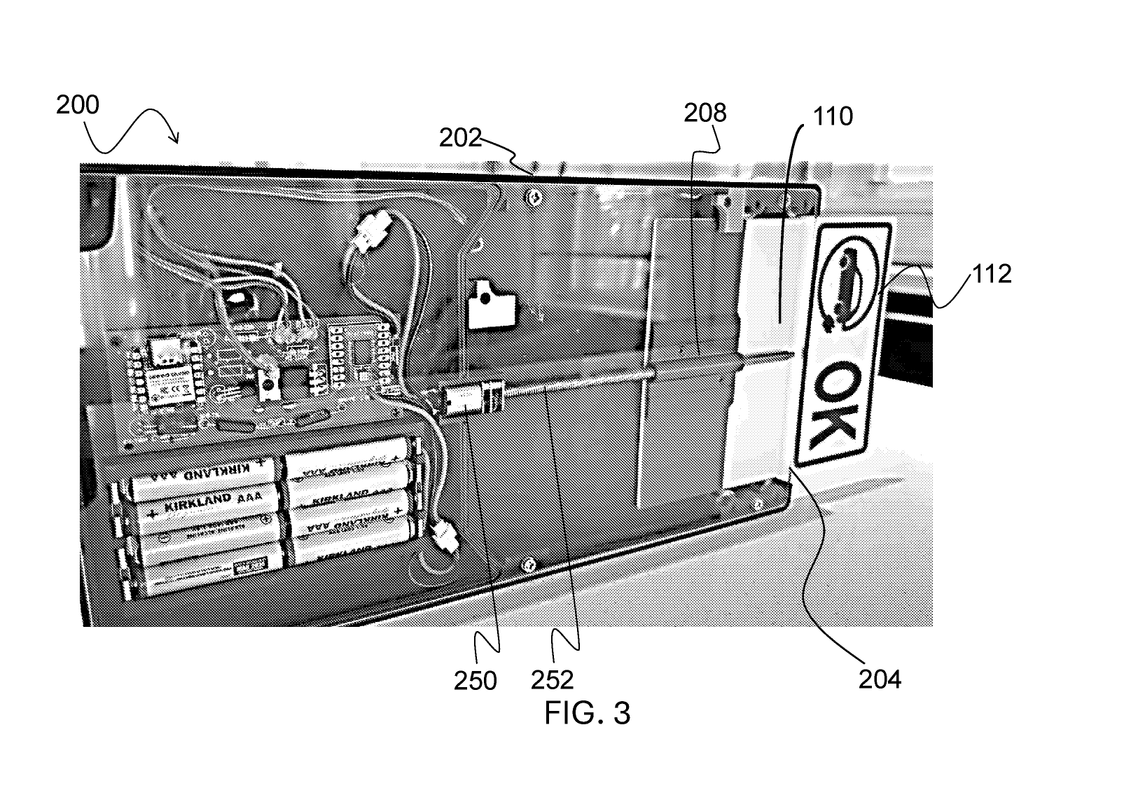

In some embodiments, magnetic limit switches control the distance that sign carrier 110 extends to. Magnetic limit switch 236A detects the magnets that are in proximity to it and triggers a signal to MCU 232. The firmware of MCU 232 counts this as number of signals received by magnetic limit switch 236A that corresponds to the number of magnets passed by sign carrier 110 when it is in motion. Examples of magnetic sensors include Hall effect sensors. A plurality of magnets (not shown) is included in (e.g., embedded in or mounted on) sign carrier 110 in line with their respective limit switches 236A and 236B. The user can control the distance of extension for sign carrier 110 by executing processor-executable instructions, e.g., running a smartphone app command. MCU 232 includes firmware which, when executed, controls the distance of extension of sign carrier 110 by turning OFF motor 250 once the pre-determined number of magnets pass by. As such, sign carrier 110 would stop its motion in a pre-determined position – e.g., closed, half-closed, half-open, open. In some embodiments, four standard 2 mm round magnets are counted to allow for full extension of sign carrier 110, as shown in FIG. 3. Similarly, the user can choose to partially extend sign carrier 110, for example, when sign carrier 110 has two signs affixed adjacent to each other and the user wishes for only one of those signs (for example, the sign at the far right) to be displayed. The firmware of MCU 232 would power ON motor 250 and extend sign carrier 110 until fewer than four magnets (for example, two magnets) are passed by sign carrier 110 and would then stop the extension of sign carrier 110 by powering OFF motor 250, which represents the desired distance of extension of sign carrier 110. A person of skill in the art will appreciate that the same principle applies when the user wishes to partially retract sign carrier 110 from full extension.

Similarly, in some embodiments, magnetic limit switch 236B is used to determine a stop position of sign carrier 110 when sign carrier 110 is being fully retracted. At least one magnet, for example, the magnets described above, or at least one other magnet (not shown) similar to the magnets described above, is also coupled to (e.g., embedded in or mounted on) sign carrier 110. In operation, the at least one magnet activates magnetic limit switch 236B when it is in proximity to magnetic limit switch 236B. The firmware of MCU 232 identifies this trigger as a signal to stop retracting sign carrier 110 and therefore turns OFF motor 250. For example, detecting the at least one magnet with magnetic limit switch 236B represents full retraction of sign carrier 110.

As shown in FIG. 2, battery 240 is electrically coupled with MCU 232, which in turn powers ON/OFF various components of slider 200, such as motor 250. Centrifugal switch 234 is triggered when the vehicle is in motion and reaches a threshold speed, for example, above 15-20 km/hr, or when the vehicle turns, rolls or leans (for example, to steer around a corner), which causes a change of its orientation. This causes a circuit completion of circuitry 230, which powers ON MCU 232 using battery 240. Circuitry 230 remains energized until turned OFF by the user, by a timer, or the like. For example, MCU 232 includes firmware which, when executed, effects a timer.

Additionally, MCU 232 includes an Inertial Measurement Unit (IMU, not shown), which allows for the detection of the vehicle’s motion. For example, if no motion is detected by the IMU, indicating the vehicle is parked or at rest, and MCU 232 (and in turn, slider 200) shuts down to conserve power. For example, if MCU 232 is turned ON by centrifugal switch 234, yet no further motion is detected by the IMU, MCU 232 will shut down. In some embodiments, centrifugal switch 234 turns ON MCU 232 initially from rest and the firmware of MCU 232 keeps slider 200 ON while IMU actively checks for motion and powers OFF slider 200 when no motion is detected. Therefore, in some embodiments, IMU and centrifugal switch 234 work in tandem, one to power ON MCU 232 (and in turn, slider 200) and one to detect if slider 200 should stay ON.

FIG. 3 illustrates a perspective view of slider 200 in an extended or open configuration. Motor 250, when activated, through lead screw 252 drives sign carrier 110 to an extended or open configuration. That is, sign carrier 110 sits proud of, away from, or at least is not mostly covered by frame 202, cover 204, or license plate 120 allowing for the content of sign carrier 110, such as sign 112 to be visible. Again, in FIG. 3, cover 204 is transparent, but in some embodiments, cover 204 is opaque.

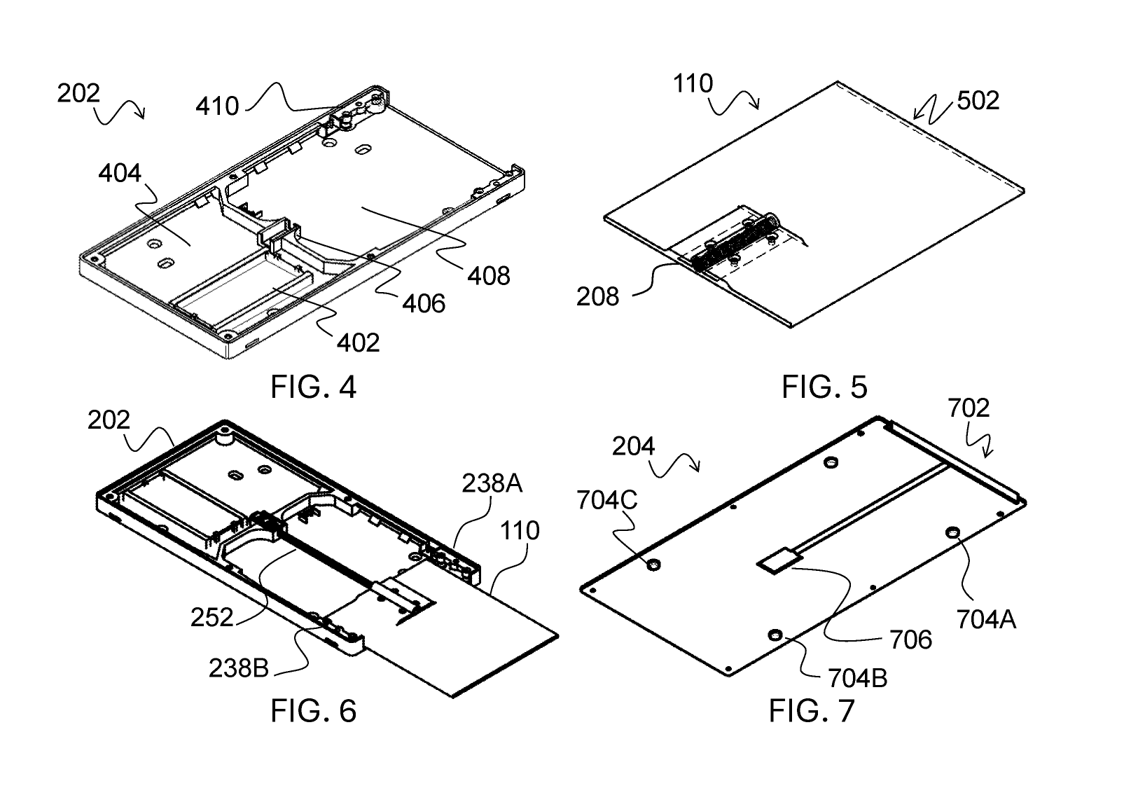

FIG. 4 illustrates a perspective view of an embodiment of frame 202. Slider 200 includes an enclosure comprising frame 202. In some embodiments, frame 202 includes a plurality of voids to receive one or parts of slider 200. For example, a first void 402 receives a power source such as battery 240. In some embodiments, frame 202 includes a second void 404 to house a plurality of circuits such as circuitry 230. Frame 202 may include a mount 406 to receive a motor such as motor 250. In some embodiments, frame 202 includes a slot 408 (fourth void) to receive in free fit or slip fit sign carrier 110. Frame 202 may include a plurality of voids to receive fasteners (e.g., threaded voids, rivet holes) used to affix objects to frame 202 or frame 202 to other devices or systems. For example, cover 204 shown in FIG. 7. In some embodiments, frame 202 includes plurality of voids 410 to hold one or more bearings such as bearings 238.

FIG. 5 illustrates a perspective view of sign carrier 110. In some embodiments sign carrier 110 includes nut 208. Nut 208 includes threads (e.g., single start thread) to receive lead screw 252. The operation of carrier 110, nut 208, and frame 202 is described herein at, at least, FIG. 2, FIG. 3, and FIG. 4. In some embodiments, sign carrier 110 receives sign 112 at distal end 502. In some embodiments, a plurality of magnets (not shown) is included in sign carrier 110.

FIG. 6 illustrates a perspective view frame 202 and sign carrier 110 in a cooperative arrangement. The perspective in FIG. 6 is different to that in FIG. 4 and FIG. 5. As shown, frame 202 is coupled to sign carrier 110 by lead screw 252. Sign carrier 110 is supported and in rolling engagement with bearing 238A and bearing 238B coupled to frame 202.

FIG. 7 illustrates a perspective view of an embodiment of cover 204. Slider 200 includes an enclosure comprising frame 202 and cover 204. The perspective in FIG. 7 is the same as in FIG. 4 and FIG. 5, but cover 204 is flipped. In some embodiments, cover 204 includes massing or voids at distal end 702 to effect an opening for sign carrier 110 or sign 112. In some embodiments, cover 204 includes a plurality of holes 704 to receive one or more fasteners. In some embodiments, cover 204 includes a plurality of voids to receive one or parts of slider 200. For example, void 706 allows for a free fit of motor 250 and lead screw 252.

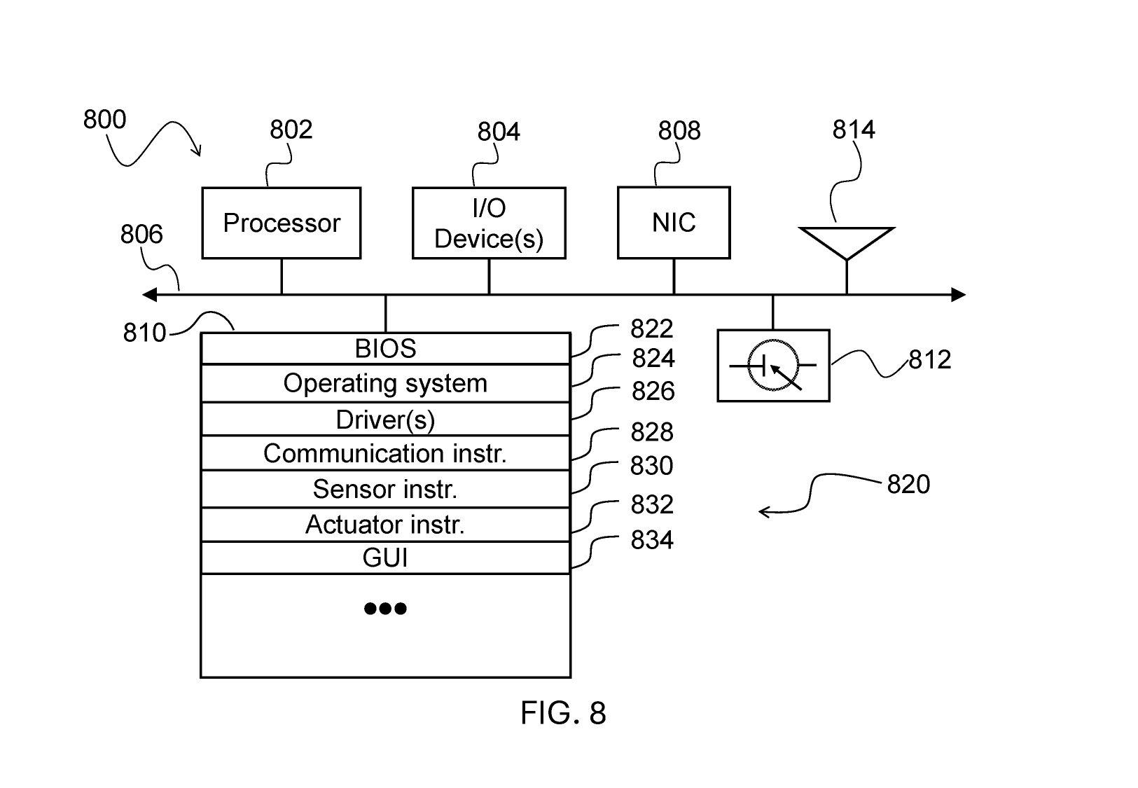

FIG. 8 illustrates a schematic view or block diagram of a plurality of circuits 800 in accordance with some embodiments of the invention. The plurality of circuits 800 includes a control subsystem comprising at least one processor 802, at least one input/output (I/O) subsystem 804, and at least one bus 806 to which, or by which, the at least one processor 802 and the I/O device(s) 804 are communicatively coupled.

In some embodiments, the plurality of circuits 800 further includes a Network Interface Card (NIC) or network interface subsystem 808 communicatively coupled to bus(es) 806, wherein network interface subsystem 808 provides bi-directional communication to other components (e.g., a system external to plurality of circuits 800) through one or more network or non-network communication channel(s) such as the internet. In some embodiments, network interface subsystem 808 includes circuitry. In other embodiments, network interface subsystem 808 uses communication protocols (e.g., FTP, HTTP, Web Services, and SOAP with XML) for bidirectional communication of information including processor-readable data, and processor-executable instructions.

Furthermore, the plurality of circuits 800 includes at least one non-transitory computer or processor-readable storage device(s) 810 coupled to the bus(es) 806. The terms ‘non-transitory computer’ and ‘processor-readable’ may be interchangeably used throughout the specification. Further, said storage device(s) 810 includes at least one non-transitory storage medium. In one embodiment, the storage device(s) 810 includes two or more distinct devices, while in another embodiment, the storage device(s) 810 includes one or more volatile storage devices (e.g., Random Access Memory (RAM)), and one or more non-volatile storage devices (e.g., Read Only Memory (ROM), flash memory, magnetic hard disk (HDD), optical disk, solid state disk (SSD), and the like). In an embodiment, the storage device(s) 810 may be implemented in a variety of ways such as a read-only memory (ROM), random access memory (RAM), a hard disk drive (HDD), a network drive, flash memory, digital versatile disk (DVD) or any such forms as may be obvious to a person skilled in the art. Further, modern computer systems and techniques conflate volatile storage and non-volatile storage, for example, caching, using solid-state devices as hard drives, in-memory data processing, and the like.

The storage device(s) 810 may store on or within the included storage media processor-readable data and/or processor-executable instructions. Storage device(s) 810 include or store processor-executable instructions and/or processor-readable data 820 associated with the operation of plurality of circuits 800 and the like in accordance with the present invention. The terms ‘processor-executable instructions’ and ‘processor-readable data’ may be interchangeably used throughout the specification.

In some embodiments, the processor-executable instructions/data 820 include a Basic Input/Output System (BIOS) 822, an operating system 824, driver(s) 826, communication instructions/data 828, sensor instructions/data 830, actuator instructions/data 832, GUI instructions/data 834, and the like.

In an exemplary scenario, the operating system 824 is ANDROID®, LINUX®, WINDOWS® or any other suitable operating system. The driver(s) 826 include processor-executable instructions/data that allows the at least one processor 802 to control one or more components in the plurality of circuits 800. The processor-executable communication instructions/data 828 implements communications between the plurality of circuits 800 and another processor-based device through network interface subsystem 808 in accordance with the invention.

The plurality of circuits 800 further includes one or more power supplies 812. In some embodiments, the power supply(ies) 812 are external power supply(ies). In contrast, in other embodiments, the power supply(ies) 812 are on-board power source(s) such as batteries, ultra-capacitors, or fuel cells, to independently power different components in accordance with the present invention.

Also, the plurality of circuits 800 includes at least one antenna 814. In response to processor-executable instructions, the antenna(e) 814 emits electronic signals and receives electronic signals in accordance with the present invention. In some embodiments antenna(e) 814 is coupled to the antenna as described in FIG. 2.

The processor-executable communication instructions/data 828, when executed, direct the plurality of circuits 800 to process input from I/O device(s) 804, antennae 814, or sensors included in a wider system, information that represents input stored on or in a storage device, e.g., storage device(s) 810.

In some embodiments, the processor-executable communication instructions 828, when executed, direct the plurality of circuits 800 to communicate with one or more other devices such as another processor-based device or a slider. The processor-executable communication instructions 828, when executed, may direct plurality of circuits 800 to communicate by antenna(e) 814.

In some embodiments, the processor-executable sensor instructions 830, when executed, direct the plurality of circuits 800 to receive and interpret information from one or more sensors. Examples of sensors include position sensors, tilt sensors, IMUs, accelerometers, and the like.

In some embodiments, the processor-executable actuator instructions 832, when executed, direct the plurality of circuits 800 to operate one or more actuators.

In some embodiments, the processor-executable GUI instructions 834, when executed, direct the plurality of circuits 800 to define and provide a graphical user interface.

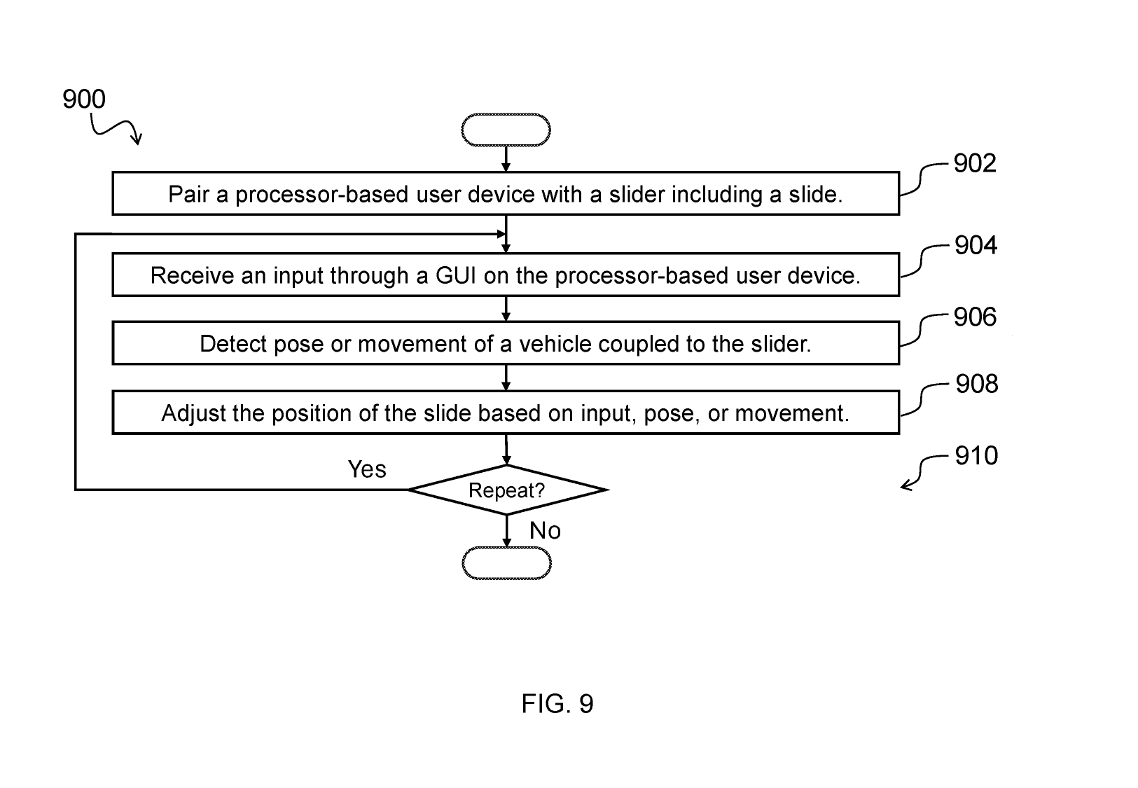

FIG. 9 illustrates an exemplary method 900 for use with the plurality of circuits such as plurality of circuits 800 and slider 200. Various embodiments of plurality of circuits 900 and slider 200 are described herein including in relation to FIG. 1, FIG. 2, FIG. 3, FIG. 4, FIG. 5, FIG. 6, FIG. 7, and FIG. 8. In particular, FIG. 9 shows method 900 that is executable by a controller, such as circuitry 230 or at least one hardware processor, for the operation, or improvement in the operation, of slider 200.

A person skilled in the art will appreciate that other acts may be included, removed, and/or varied or performed in a different order to accommodate alternative implementations. Method 900 may be implemented at the bus(es) 806 through the one or more network or non-network communication channel(s) such as internet. The method 900 may be performed by the at least one processor 802 in conjunction with other components or systems as may be obvious to a person skilled in the art. In some embodiments, the at least one processor 802 may refer to a controller, for example, a controller subsystem, or a hardware processor.

At 902, the at least one processor pairs a processor-based user device with slider 200 including sign carrier 110. For example, pair plurality of circuits 800 with slider 200. To pair a plurality of devices includes coupling two or more devices so they can communicate with each other. This is commonly done using BLUETOOTH® or another short-range radio communication. The process can include a discovery phase where a first device searches for other devices in the vicinity, and a request phase where the device sends a coupling request to the other device. Authentication can be used where the devices exchange information, such as a passcode or PIN, to ensure the communication is with the correct devices. Encryption can be used to secure the communication. Once paired, the devices can remember each other, and this can reconnect automatically/

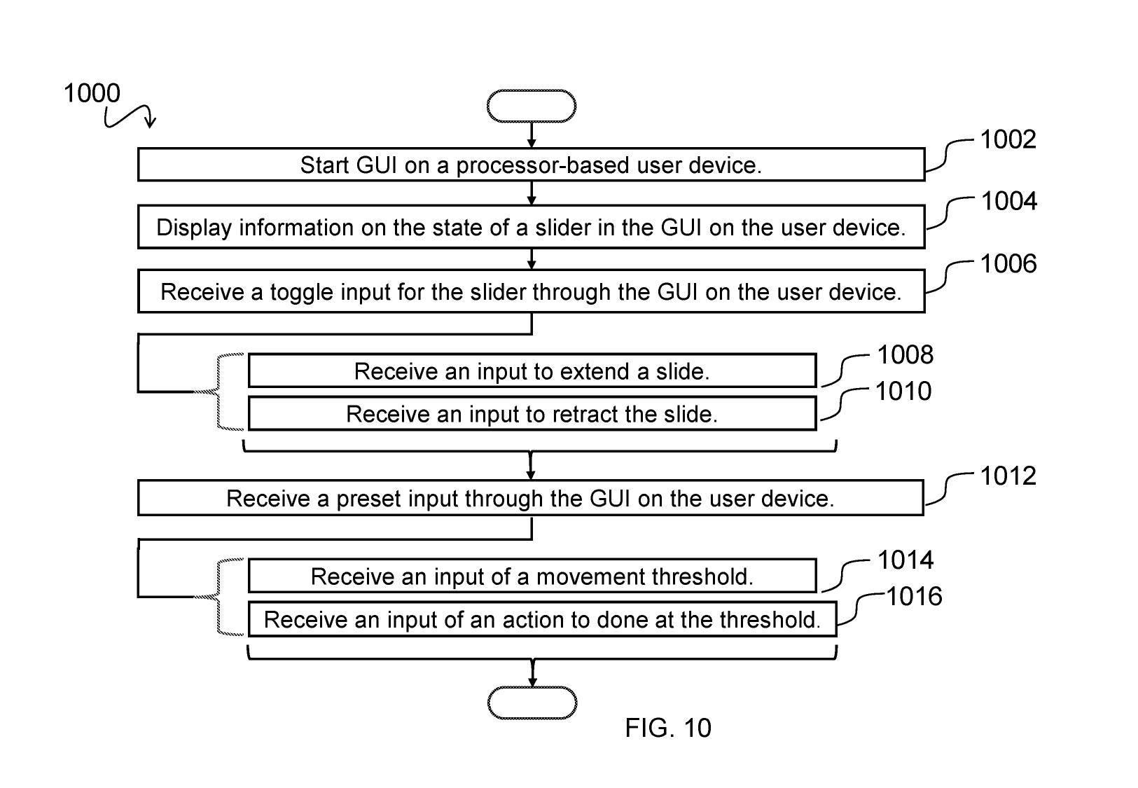

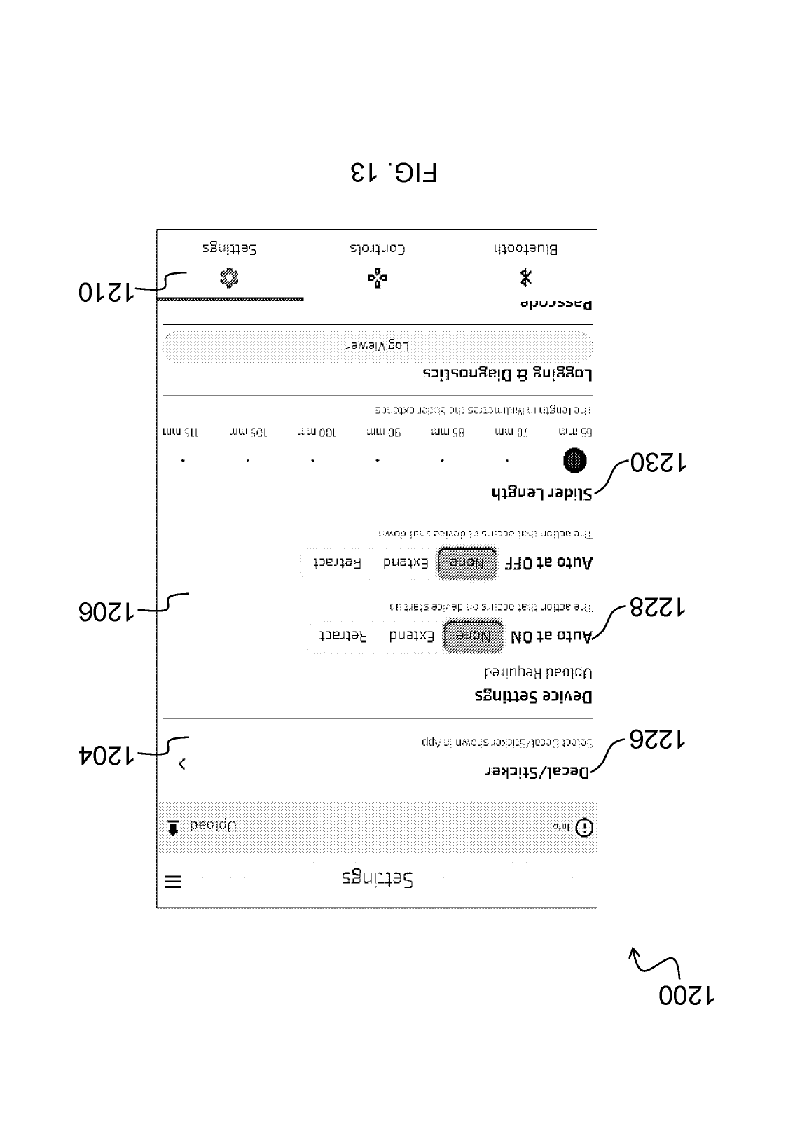

At 904, the at least one processor receives an input through a GUI on the processor-based user device. For example, the at least one processor receives an input from the GUI 834. Examples of inputs are described herein in relation to, at least, FIG. 10 and FIG. 12.

At 906, the at least one processor detects the pose or movement of a vehicle coupled to slider 200. For example, detects a pose or a change in pose. In some embodiments, the at least one processor detects movement by way of velocity, acceleration, or jerk.

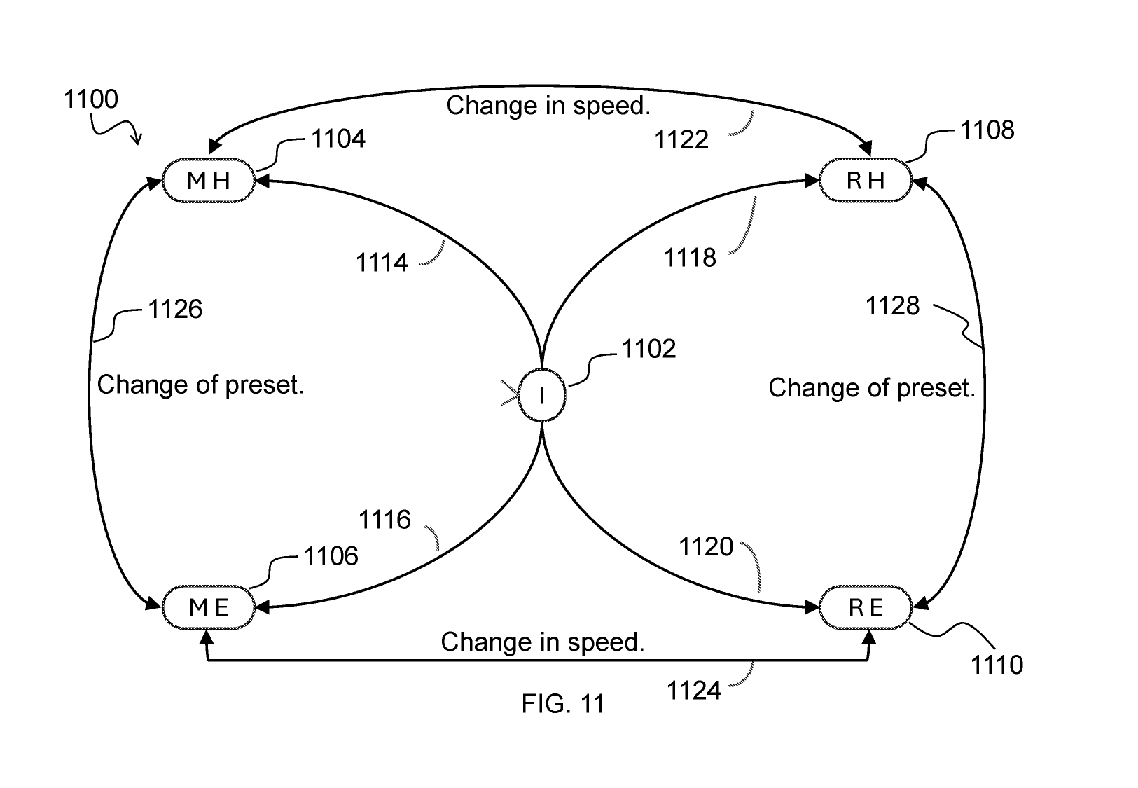

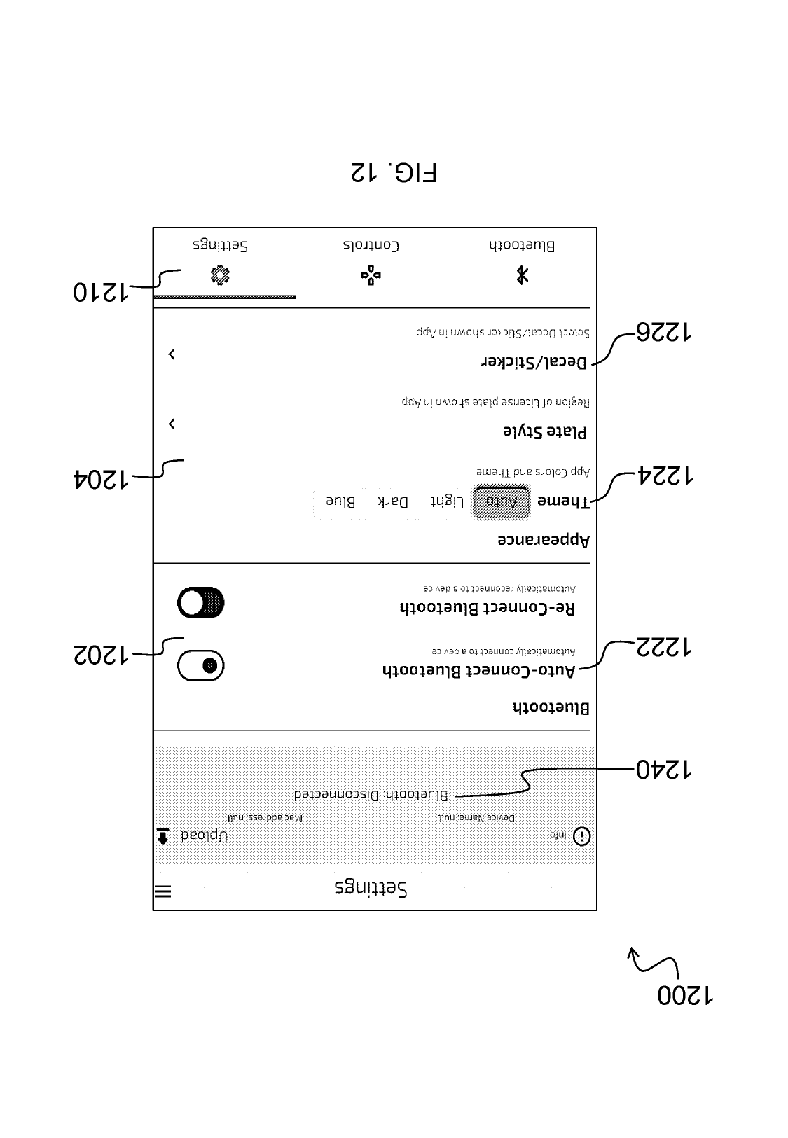

At 908, the at least one processor adjusts the position of sign carrier 110 given input, pose, or movement. For example, user input and movement. Examples of adjusting sign carrier 110 given input, pose, or movement are described herein in relation to, at least, FIG. 11 and FIG. 12.

At 910, the at least one processor checks if parts of method 900 are to repeat. If 910-Yes processing continues, in some embodiments, at 904. If 910-No, method 908 ends until invoked again.

FIG. 10 illustrates an exemplary method 1000 for use with the plurality of circuits, such as plurality of circuits 800 and slider 200. Method 1000 is executable by a controller, such as circuitry or at least one hardware processor, for the operation, or improvement in the operation, of slider 200.

A person skilled in the art will appreciate that in method 1000 and other methods disclosed herein other acts may be included, and disclosed acts removed, and/or varied or performed in a different order to accommodate alternative implementations.

Method 1000 begins at 1002. At 1002, the at least one processor starts a GUI on a processor-based user device. For example, the at least one processor executes GUI instructions 834.

At 1004, the at least one processor states information on the state of slider 200 on the GUI provided by the processor-based user device. For example, the at least one processor shows sign carrier 110 is extended or retracted. In some implementations, the GUI displays information on the defined behaviour of slider 200 based on input, position, and movement.

At 1006, the at least one processor receives a toggle input for slider 200 through the GUI on the user device. A toggle input is a simple request to change the state of slider 200. For example, at 1008, the at least one processor receives processor-executable instructions to extend sign carrier 110. In some cases, at 1010, the at least one processor receives processor-executable instructions to retract sign carrier 110. In some implementations, at 1008, the at least one processor receives a request to execute and executes processor-executable instructions to extend sign carrier 110. In some implementations, at 1010, the at least one processor receives a request to execute and executes processor-executable instructions to retract the sign carrier 110.

At 1012, the at least one processor receives a preset input through the GUI on the user device. A preset input includes information received from a user through the GUI characterizing a parameter or a behaviour. For example, at 1014, the at least one processor receives an input of a movement threshold. In some implementations, the movement threshold is a speed threshold. In some implementations, the movement threshold is selected from the group consisting of an acceleration threshold. A threshold can define the boundary between in motion and at rest. A threshold can define a rate at which a behaviour starts or stops.

In some implementations, at 1016, the at least one processor receives an input characterizing an action to be done at the threshold. For example, to extend sign carrier 110 and display sign 112 when reaching a speed threshold. Or changing the position of sign carrier 110 after a certain distance travelled. In some implementations, the action is based on a threshold of acceleration or jerk.

FIG. 11 illustrates a state diagram 1100 associated with some embodiments and useful to show the behaviour of these embodiments and to create processor-executable instructions. State diagram 1100 graphically represents the state of a system, for example, a slider such as slider 200, or a slider coupled to a plurality of circuits, such as plurality of circuits 800. A state diagram shows how a slider changes state based on inputs. FIG. 11 could be equally well represented as a state transition table.

The state diagram 1100 includes a directed graph comprising a plurality of nodes corresponding to states of the system and a plurality of edges where each edge is a transition between two states. The edges correspond to inputs, for example, by a user or from a sensor, and effect a change of state.

The state diagram 1100 includes an initial state 1102 where the system begins, and a plurality of non-initial states 1104 – 1110 (even numbers only). State 1104 corresponds to the vehicle in motion (M) and sign carrier 110 being hidden (H) for a composite state MH. State 1110 corresponds to the vehicle in at rest (R) and sign carrier 110 being extended (E) for a composite state RE. State 1106 and state 1108 are the other combinations.

In some embodiments, the state of motion is any recorded movement by way of velocity, acceleration, or jerk. In some embodiments, in motion is speed above a threshold. So, for example, state 1104 and state 1106 could correspond to a vehicle moving at or above 20 km/h. In some embodiments, velocity is measured by a change in position over time when the position is provided from a sensor communicatively coupled to a positioning system such as GPS, BeiDou, Galileo, GLONASS, or Loran. In some embodiments, velocity is measured by monitoring rotation of the tires. In some embodiments, velocity is measured by processing a plurality of images received from an image mounted on the vehicle.

A first plurality of edges 1114 – 1120 (even number only) corresponds to a transition from the initial state. For example, edge 1114 is a transition to state 1104, where the vehicle is in motion and sign carrier 110 with attached sign 112 is hidden. Edge 1118 is a transition to state 1108 when the vehicle is at rest, and sign carrier 110 with attached sign 112 is hidden. Edge 1116 and edge 1120 correspond to further transitions from the initial state.

In some embodiments, state diagram 1100 includes a second and third plurality of edges. A second plurality of edges (e.g., edge 1122 and edge 1124) correspond to a change in speed. For example, a change from at rest to in motion, or a change from one side of a threshold to another. A third plurality of edges (e.g., edge 1126 and edge 1128) correspond to a change in configuration. For example, a change from extend to hide.

In some embodiments, state diagram 1100 is used to affect a plurality of behaviours. For example, “Auto Deploy on ON” where the system displays sign 112 when the system is turned ON. For use with say a new driver sign. Or for example, “Auto Retract on ON” where the system hides sign 112 when the system is turned ON. Other behaviours are possible. For example, “Auto Deploy on OFF” where the system displays sign 112 when the system is turned OFF. For example, useful with a sign indicating eligibility to park in a certain location. Also consider “Auto Retract on OFF” where the system hides sign 112 when the system is turned OFF, either by the firmware timers of MCU 232 or the IMU. In some embodiments, ON and OFF are inferred from motion sensors.

Various other features not shown in FIG. 11 can also be implemented. In some embodiments, slider 200 can have more than one sign 112 (for example, two signs) affixed to it which allows for partial extension/retraction of slider 200. Each option will have a different application from being a convenient feature useful to those who are forgetful to an automated sign display. Furthermore, the various power-saving options described earlier ensure long-lasting battery life independent of the vehicle.

FIG. 12 and FIG. 13 illustrate an example user device interface (GUI) 1200, which, when invoked, controls slider 200. A first part of user device interface (GUI) 1200 is shown in FIG. 12 and a second part is shown in FIG. 13. For example, the user of a processor-based user device scrolls between the view in FIG. 12 and the view shown in FIG. 13. In some embodiments, a processor or controller (e.g., processor 802) executes processor-executable instructions to present GUI 1200 to a user. For example, on a processor-based device, such as a smartphone.

Graphical user interfaces described herein, like GUI 1200, may include one or more user-selectable and operable controls (e.g., buttons, dialog boxes, dials, icons, pull-down menus, slides, toggles, and toolbars) which permit a user to provide input. The input may indicate a desire or directive to change state or behaviour of a slider, e.g., slider 200. In some embodiments, the input may include a directive to adjust the position of the slider. For example, control 1228 allows the user to select the position of slider 200 when slider 200 is activated, from a plurality of options such as “None”, “extend” or “retract” which corresponds to the change of preset as described in FIG. 11. The input may be a toggle input or a present input.

As shown in FIG. 12 and FIG. 13, in some embodiments, GUI 1200 includes a main menu 1210, which includes options such as “Bluetooth”, “Controls” and “Settings” which allows the user to conveniently view and control connection status, quick control options such as extend or retract sign carrier 110 as well as user-specified slider settings. FIG. 12 and FIG. 13 show GUI 1200 when a user has selected to view the “Settings” option of main menu 1210, which includes a first portion 1202, a second portion 1204, a third portion 1206 and a status indicator 1240.

In some embodiments, first portion 1202 of GUI 1200 includes a set of connection controls or a display. For example, control 1222 allows the user to select whether or not slider 200 can automatically connect to a processor-based user device, such as a smartphone, whenever slider 200 is activated. The connection can be established by a low-power network such as BLUETOOTH® wireless communication.

In some embodiments, second portion 1204 of GUI 1200 includes a set of appearance controls or display elements. For example, control 1224 allows the user to select the appearance/background of GUI 1200 from a plurality of options such as “Auto”, “Light”, “Dark”, etc. and control 1226 allows the user to select sign 112 from a plurality of signs which corresponds to the sign that is currently affixed to sign carrier 110. In other words, the user can select an image of a sign that matches sign 112 from a plurality of images of signs stored as processor-readable data stored in a processor-readable storage device, such as storage devices 810 of FIG. 8. This allows the user to remember which sign would be displayed/being displayed by slider 200.

In some embodiments, third portion 1206 of GUI 1200 includes a set of behaviour controls or display elements, for example, control 1228, which allows the user to select the position of slider 200 when slider 200 is activated and control 1230, which allows the user to select the distance of extension of sign carrier 110. In some embodiments, status indicator 1240 of GUI 1200 includes information such as the status of short-range wireless communication, for example, a BLUETOOTH® communication channel, between slider 200 and the user device.

A person of skill in the art will appreciate that slider 200 can be designed with various other or a combination of various electrical and mechanical components. For example, in some embodiments, motor 250 and lead screw 252, which in combination act as a linear actuator. In some embodiments, slider 200 can include a belt drive/pulley or a rack and pinion system. In some embodiments, limit switches 236 and centrifugal switch 234 can be replaced or work in conjunction with other sensors and firmware timers. Similarly, motor 250 can be two smaller motors or a larger capacity motor and battery 240 can include a different type of battery that can power circuitry 230.

Each document cited herein was cited to provide clarity to the reader and is incorporated by reference in its entirety. In cases where the present disclosure conflicts with a document incorporated by reference, the present disclosure controls.

While the disclosure has been described in connection with specific embodiments, it is to be understood that the disclosure is not limited to these embodiments and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

The above description illustrates various embodiments of the present disclosure along with examples of how aspects of particular embodiments may be implemented. The above examples should not be deemed to be the only embodiments or implementations, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A device for the selective display of a sign on a vehicle, the device comprising:
a frame including a first side and a second side, which in operation is coupled to the vehicle on the first side of the frame and receives a license plate on the second side of the frame;
a sign carrier to receive the sign;
an actuator coupled to the frame and the sign carrier, which in operation moves the sign carrier from a first position to a second position;
a power supply coupled to the frame and electrically coupled to the actuator; and
a controller communicatively coupled to the actuator.

2. The device of claim 1, wherein the first position hides a first part of the sign behind the license plate or the frame, and the second position displays the sign clear of the frame and the license plate.

3. The device of claim 1, wherein the sign carrier is in a sliding engagement with the frame.

4. The device of claim 3, further comprising a plurality of bearings separating the frame from the sign carrier.

5. The device of claim 1, wherein the actuator is a linear actuator.

6. The device of claim 5, wherein the linear actuator includes a motor, a lead screw coupled to the motor, a threaded body coupled to the sign carrier and threaded on the leadscrew.

7. The device of claim 1, wherein the actuator is selected from the group consisting of a rack and pinion, a belt drive, and a linear actuator.

8. A system comprising:
a user device, wherein the user device is processor-based;
at least one processor communicatively coupled to the user device; and
at least one non-transitory processor-readable storage device communicatively coupled to the at least one processor and which stores processor-executable instructions which, when executed by the at least one processor, cause the at least one processor to:
receive a user input through a GUI on the processor-based user device, wherein the user input specifies a behavior for a slider communicatively coupled to the user device;
detect pose or movement of a vehicle coupled to a sign carrier; and
adjust the position of the sign carrier based on the user input, pose of the sign carrier, or movement of the sign carrier.

9. The system of claim 8, further comprising a slider communicatively coupled to the at least one processor, and wherein the slider comprises: an actuator coupled to the sign carrier.

10. The system of claim 9, wherein when executed, the processor-executable instructions further cause the at least one processor to pair the user device with the slider including the sign carrier.

11. The system of claim 8, wherein when executed, the processor-executable instructions further cause the at least one processor to receive a toggle input for the slider through the GUI on the processor-based user device.

12. The system of claim 8, wherein when executed, the processor-executable instructions further cause the at least one processor to receive a preset input for the slider through the GUI on the processor-based user device.

13. The system of claim 12, wherein when executed, the processor-executable instructions further cause the at least one processor to receive a speed threshold through the GUI on the processor-based user device.

14. The system of claim 12, wherein when executed, the processor-executable instructions further cause the at least one processor to receive a movement threshold through the GUI on the processor-based user device.

15. The system of claim 14, wherein when executed, the processor-executable instructions further cause the at least one processor to receive, through the GUI on the processor-based user device, an action to be done upon reaching the movement threshold.

16. The system of claim 8, wherein:
the sign carrier is coupled to a vehicle;
the sign carrier may receive a sign;
the movement of the sign carrier includes movement of the sign carrier by way of movement of the vehicle;
the position of the sign carrier is relative to the vehicle wherein a first position hides the sign, and a second position displays the sign; and
when executed, the processor-executable instructions further cause the at least one processor to adjust the position of the sign carrier from the first position to the second position, or from the second position to the first position.
